(19) United States
(12) Patent Application Publication
(10) Pub. No.: US 2015/0110587 A1
(43) Pub. Date: Apr. 23, 2015

(54) ARTICLE TRANSPORT SYSTEM, LIBRARY APPARATUS, AND ARTICLE TRANSPORT METHOD

(71) Applicant: FUJITSU LIMITED, Kawasaki-shi (JP)

(72) Inventor: Daisuke HORI, Yokohama (JP)

(21) Appl. No.: 14/459,570

(22) Filed: Aug. 14, 2014

(30) Foreign Application Priority Data
Oct. 23, 2013 (JP) 2013-220514

(51) Int. Cl. B65G 65/00; B65G 49/05; B65G 61/00

(52) U.S. Cl. CPC B65G 65/005; B65G 61/00; B65G 49/05; B65G 2201/02; B65G 2812/0299
USPC 414/267; 414/807

(57) ABSTRACT

An article transport system includes: a first transport device configured to transport an article within a first article storage area or a second article storage area; a second transport device configured to transport the article between the first article storage area and the second article storage area; an alternative power supplier configured to supply the second transport device with first power output by a first power part in the first transport device; and a power switcher configured to switch a power source for the second transport device from a second power part in the second transport device to the alternative power supplier, based on operation of the first transport device.

### CROSS-REFERENCE TO RELATED APPLICATION

This application is based upon and claims the benefit of priority from the prior Japanese Patent Application No. 2013-220514 filed on Oct. 23, 2013, the entire contents of which are incorporated herein by reference.

### FIELD

The embodiments discussed herein are related to an article transport system, a library apparatus, and an article transport method.

### BACKGROUND

A library apparatus stores many transportable recording media in a casing and is configured to perform automated writing or reading of recording data. The library apparatus incorporates a transport device configured to transport the transportable recording media.

Related techniques are disclosed in Japanese Laid-open Patent Publication Nos. 05-307820 and 08-221866.

### SUMMARY

According to an aspect of the embodiments, an article transport system includes: a first transport device configured to transport an article within a first article storage area or a second article storage area; a second transport device configured to transport the article between the first article storage area and the second article storage area; an alternative power supplier configured to supply the second transport device with first power output by a first power part in the first transport device; and a power switcher configured to switch a power source for the second transport device from a second power part in the second transport device to the alternative power supplier, based on operation of the first transport device.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 illustrates an example of a library apparatus;

FIG. 2 illustrates an example of a library apparatus;

FIG. 3 illustrates an example of a perspective view of an upper robot and a lower robot;

FIG. 4 illustrates an example of a library apparatus;

FIG. 5 illustrates an example of a perspective view of an alternative power supplier and a power switcher;

FIG. 6 illustrates an example of a perspective view of an alternative power supplier;

FIG. 7A illustrates an example of an enlarged view of a first transmission shaft and a second transmission shaft;

FIG. 7B illustrates an example of an enlarged view of a drive chain;

FIGS. 8A to 8C illustrate an example of an operation of an alternative power supplier;

FIG. 9 illustrates an example of a power switcher;

FIG. 10 illustrates an example of a swing member and a timing belt;

FIG. 11 illustrates an example of a link mechanism;

FIG. 12A illustrates an example of a front view of a link mechanism;

FIG. 12B illustrates an example of plan view of a link mechanism;

FIG. 12C illustrates an example of a side view of a link mechanism;

FIGS. 13A to 13C illustrate an example of an operation of a the power switcher;

FIG. 14A illustrates an example of a state where a power source for a second transport device is a motor of the second transport device;

FIG. 14B illustrates an example of a state where a power source for a second transport device is an alternative power supplier;

FIG. 15 illustrates an example of a control of an article transport system;

FIG. 16 illustrates an example of a control of a power switcher; and

FIG. 17 illustrates an example of a control of a alternative power supplier.

### DESCRIPTION OF EMBODIMENTS

In a library apparatus, multiple casings are coupled and operated together to increase the storage capacity. The library apparatus with the multiple casings coupled to one another includes, besides a transport device installed in each casing, a transport device configured to transport a transportable recording medium between the casings. If the transport device has a problem, an operation of the library apparatus is affected. As a precaution against a failure occurring in the transport device, for example, a library apparatus with multiple casings redundantly has multiple transport mechanisms for transporting a transportable recording medium between the casings. In addition, for example, in the library apparatus, an accessor configured to transport a recording medium between a medium storage portion and a recording-reproduction unit is provided with two travelling motors, so that when one of the two travelling motors has a problem, the other normally-operating one may be selected.

For example, in the case of having the multiple transport mechanisms, costs may increase since multiple drive components or control circuits are prepared. In the case of providing two travelling motors to the accessor, costs may increase.

The dimensions, ratios, and the like of elements in the drawings may be different from actual values. For the convenience of illustration, some drawings may not illustrate components that are actually present.

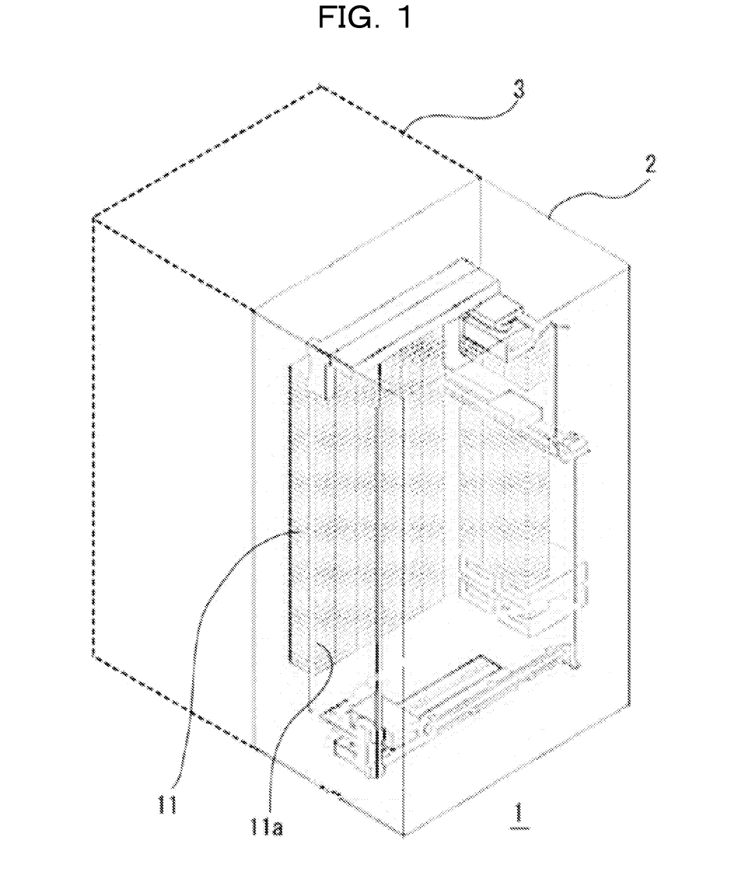

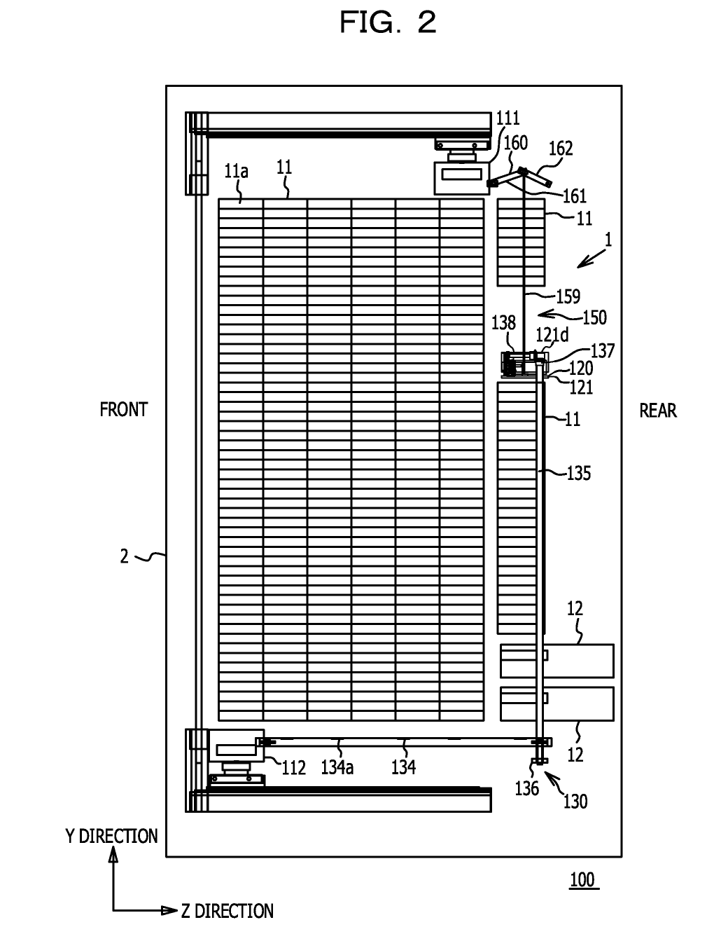

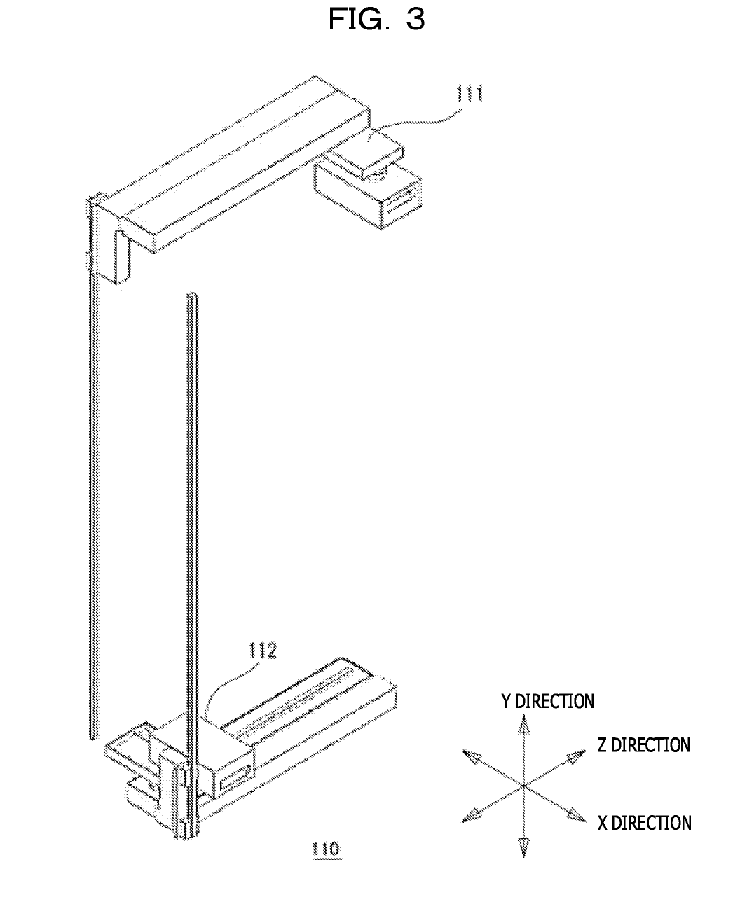

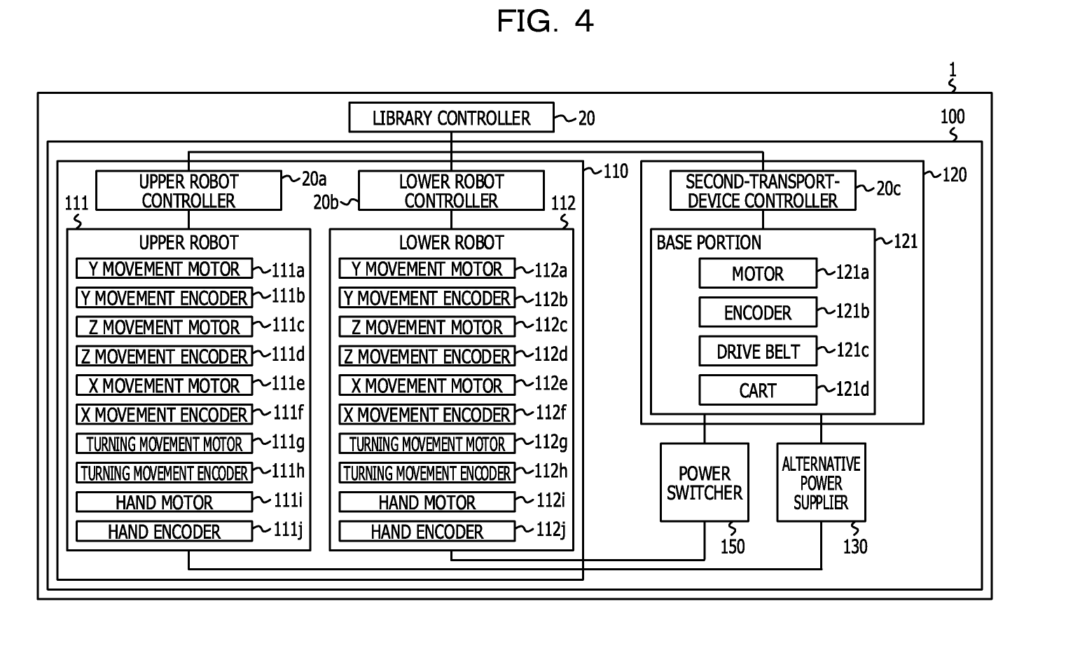

FIG. 1 illustrates an example of a library apparatus. FIG. 1 illustrates a library apparatus 1 incorporating an article transport system 100. FIG. 2 illustrates an example of a library apparatus. FIG. 2 illustrates the inside of the library apparatus 1 incorporating the article transport system 100. FIG. 3 illustrates an example of a perspective view of an upper robot and a lower robot. FIG. 3 illustrates a perspective view of an upper robot 111 and a lower robot 112 of the article transport system 100. FIG. 4 illustrates an example of a library apparatus. FIG. 4 illustrates a block diagram of a library apparatus 1 incorporating the article transport system 100. In the following description, front and rear directions are set as depicted in FIG. 2, and X, Y, and Z directions are set as depicted in FIG. 3.

The library apparatus 1 includes a first casing 2 and a second casing 3. The first casing 2 may correspond to a first article storage area. The second casing 3 may correspond to a second article storage area. The library apparatus 1 incorporates the article transport system 100. An article transported by the article transport system 100 may be a transportable recording medium such as an optical disk. A magnetic tape may be transported as the transportable recording medium. Each of the first casing 2 and the second casing 3 has lockers 11 installed therein, each locker 11 being provided with multiple slots 11a. Each of the first casing 2 and the second casing 3 includes a first transport device 110 inside. The first transport device 110 includes the upper robot 111 and the lower robot 112 as illustrated in FIG. 3. The upper robot 111 may correspond to a first operation part. The lower robot 112 may correspond to a second operation part. The upper robot 111 and the lower robot 112 move an article in their casing. For example, the upper robot 111 and the lower robot 112 transport an optical disk between the slot 11a and a device for carrying in and out optical disks and between the slot 11a and a drive 12.

As illustrated in FIG. 4, the upper robot 111 includes a Y movement motor 111a, a Y movement encoder 111b, a Z movement motor 111c, a Z movement encoder 111d, an X movement motor 111e, an X movement encoder 111f, a turning movement motor 111g, a turning movement encoder 111h, a hand motor 111i, and a hand encoder 111j. These are electrically coupled to an upper robot controller 20a. The upper robot controller 20a is electrically coupled to a library controller 20. Like the upper robot 111, the lower robot 112 includes various motors and various encoders as illustrated in FIG. 4, and also includes a lower robot controller 20b to which the motors and encoders are electrically coupled. The lower robot controller 20b is electrically coupled to the library controller 20. As illustrated in FIG. 2, a main portion of the upper robot 111 is located in a space above the lockers 11, and a main portion of the lower robot 112 is located in a space below the lockers 11. The library controller 20 may function as a controller of an alternative power supplier 130 and a power switcher 150.

The first transport device 110 may be used to actuate the power switcher 150 configured to switch a power source for a second transport device 120 from a power part of the second transport device 120 to the alternative power supplier 130. The first transport device 110 may be provided in each of the first casing 2 and the second casing 3. The first transport device 110 provided inside the first casing 2 may be used as the alternative power source for the second transport device 120 and to actuate the power switcher 150. Instead of the first transport device 110 provided inside the first casing 2, the first transport device 110 provided inside the second casing 3 may be used for the actuation described above.

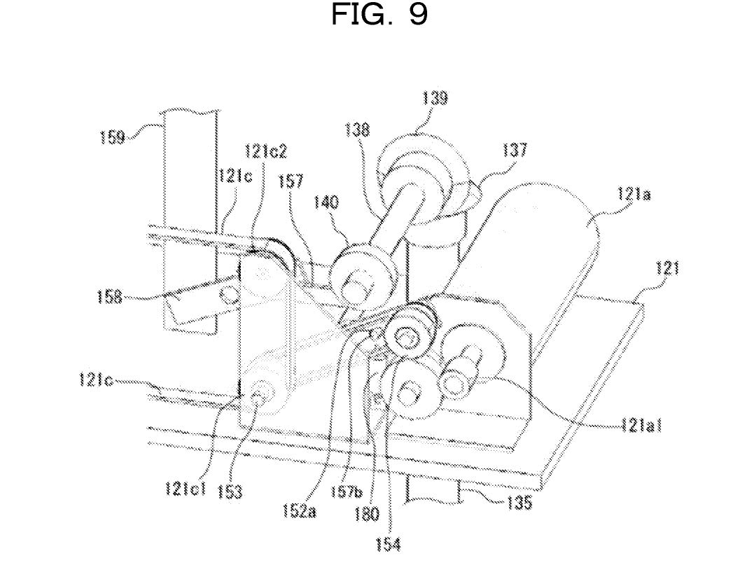

The first casing 2 and the second casing 3 are coupled to each other. The article transport system 100 includes the second transport device 120 configured to transport an article between the first casing 2 and the second casing 3. For example, the second transport device 120 transports an optical disk between the first casing 2 and the second casing 3. The second transport device 120 may be provided at a position slightly above a middle section of the lockers 11 in which the slots 11a are stacked vertically. The second transport device 120 includes a plate-shaped base portion 121 extending across a space between the first casing 2 and the second casing 3. A motor 121a, which is the power part of the second transport device 120, is placed on the base 121. The second transport device 120 includes an encoder 121b configured to monitor the rotation status of the motor 121a. A drive belt 121c is looped along the base portion 121 between the first casing 2 and the second casing 3. A cart 121d is attached to the drive belt 121c. The cart 121d retains an optical disk and moves back and forth between the first casing 2 and the second casing 3. The drive belt 121c is driven by the motor 121a via a pinion gear 121a1 attached to the motor 121a, a drive pulley 121c1, and a driven pulley 121c2 (illustrated in FIG. 9). The motor 121a is electrically coupled to a second-transport-device controller 20c. The second-transport-device controller 20c is electrically coupled to the library controller 20.

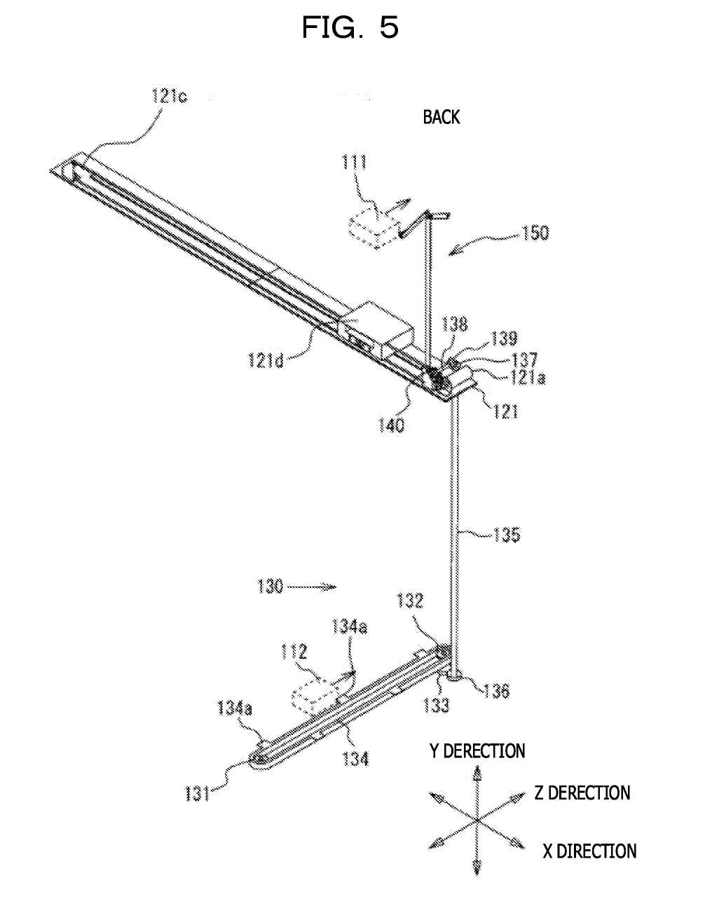

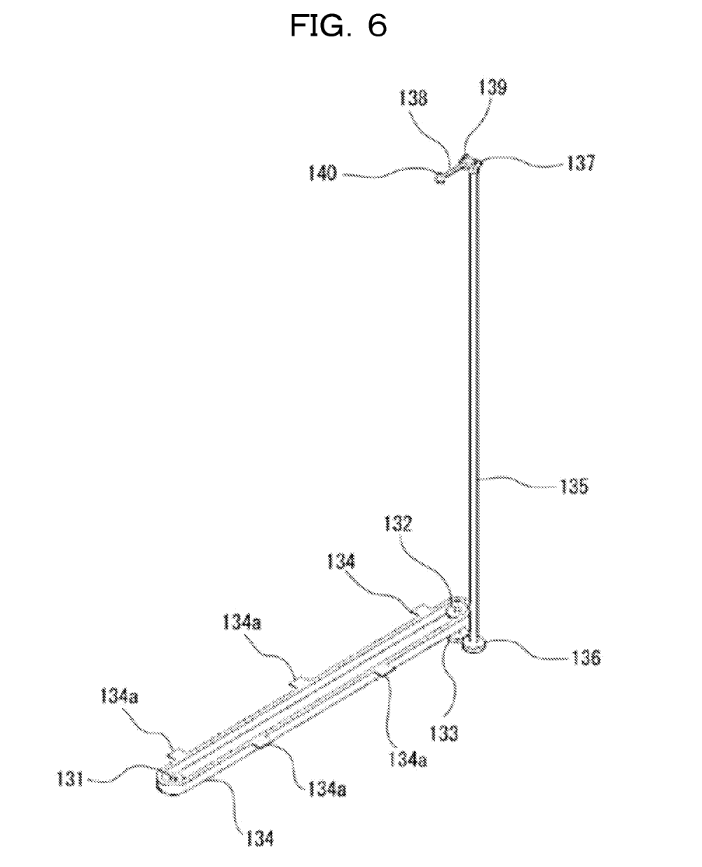

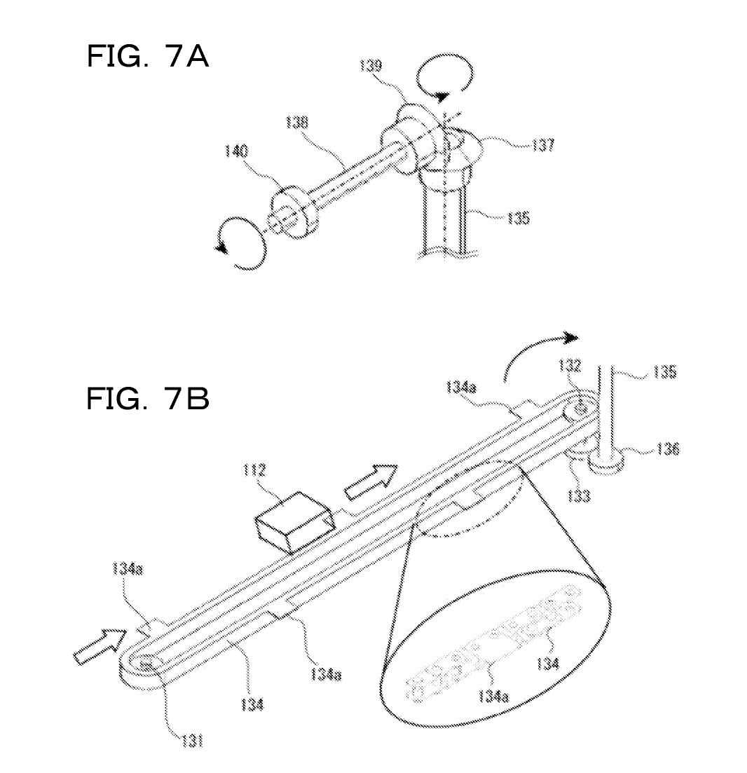

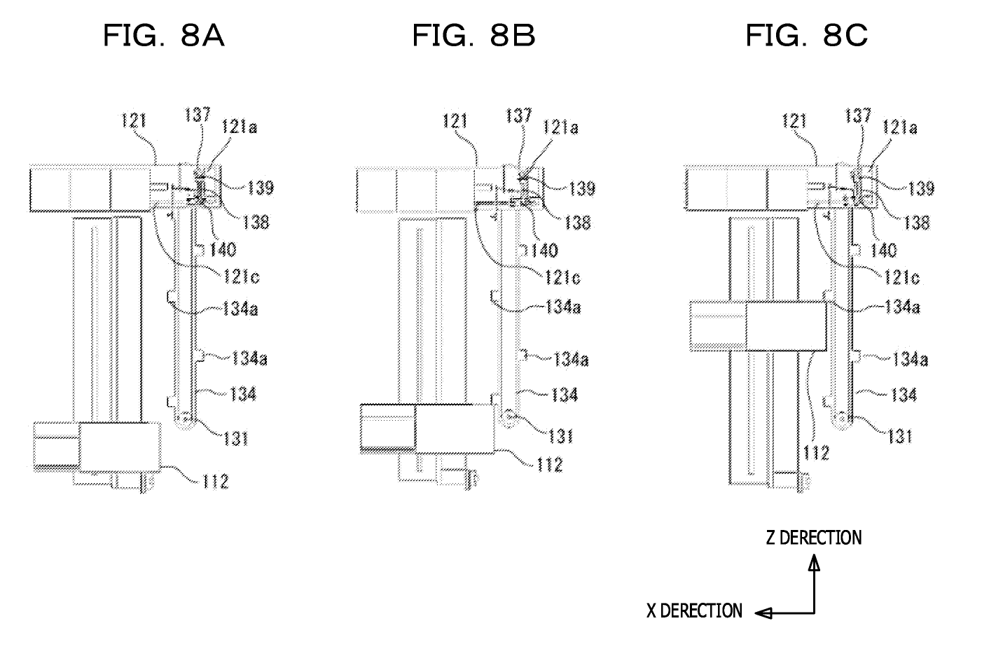

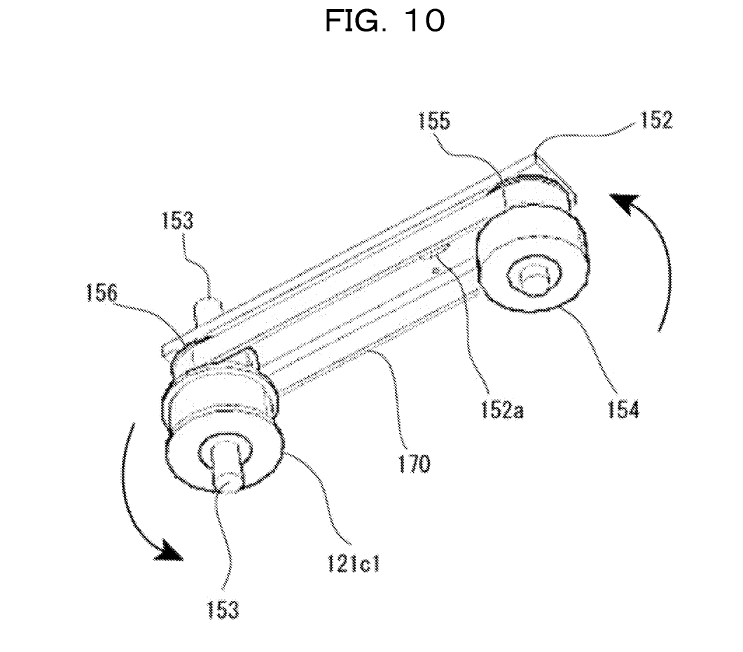

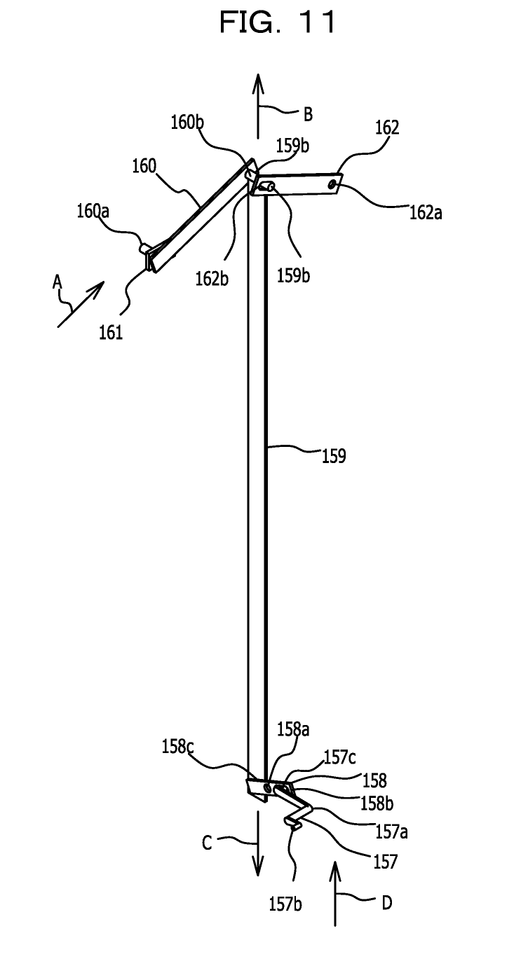

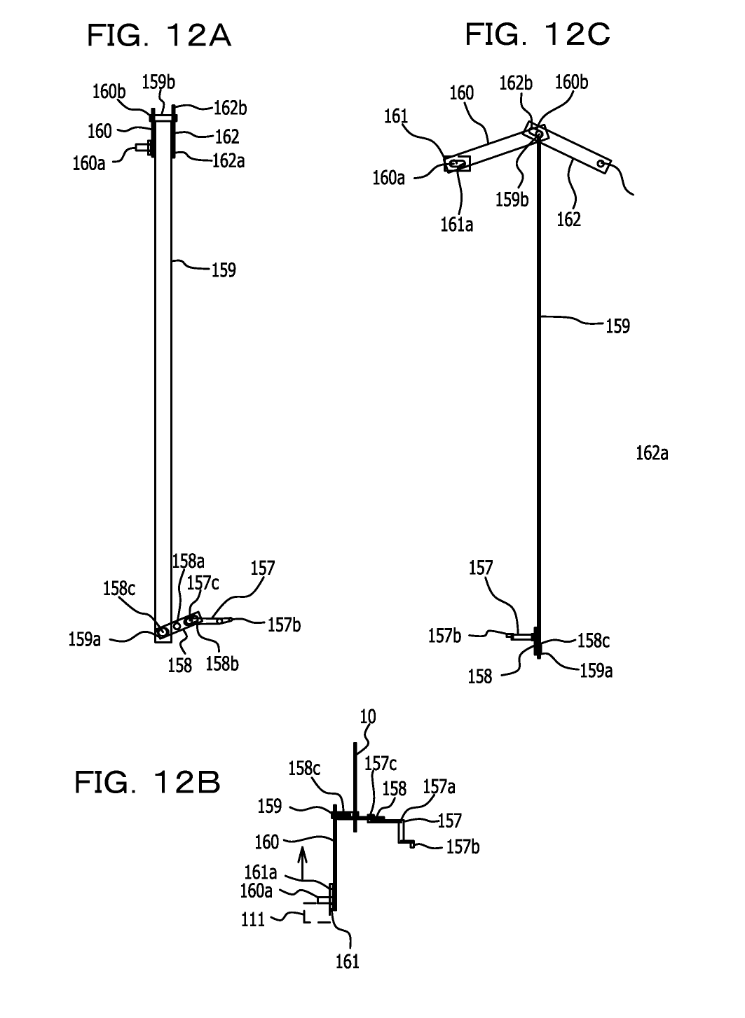

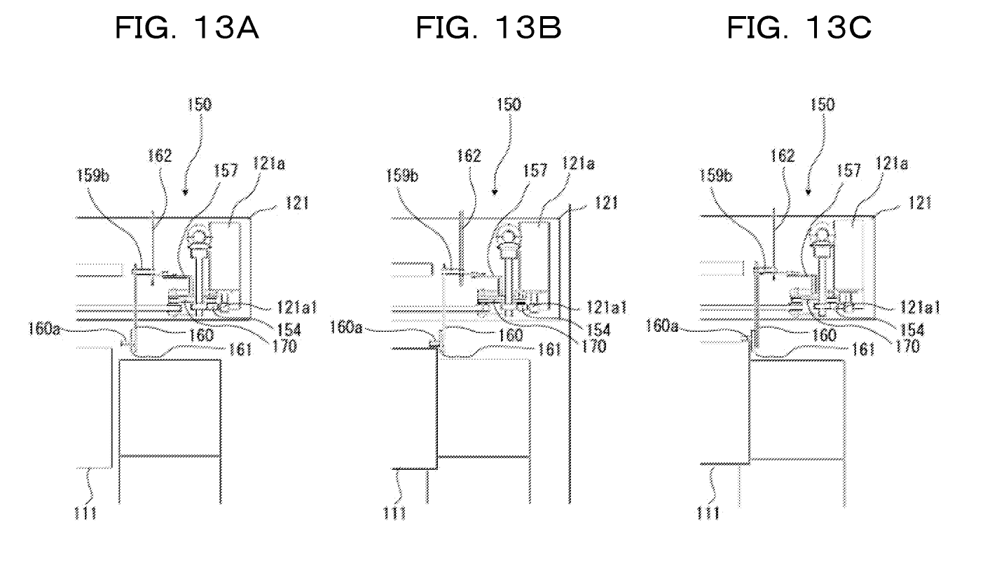

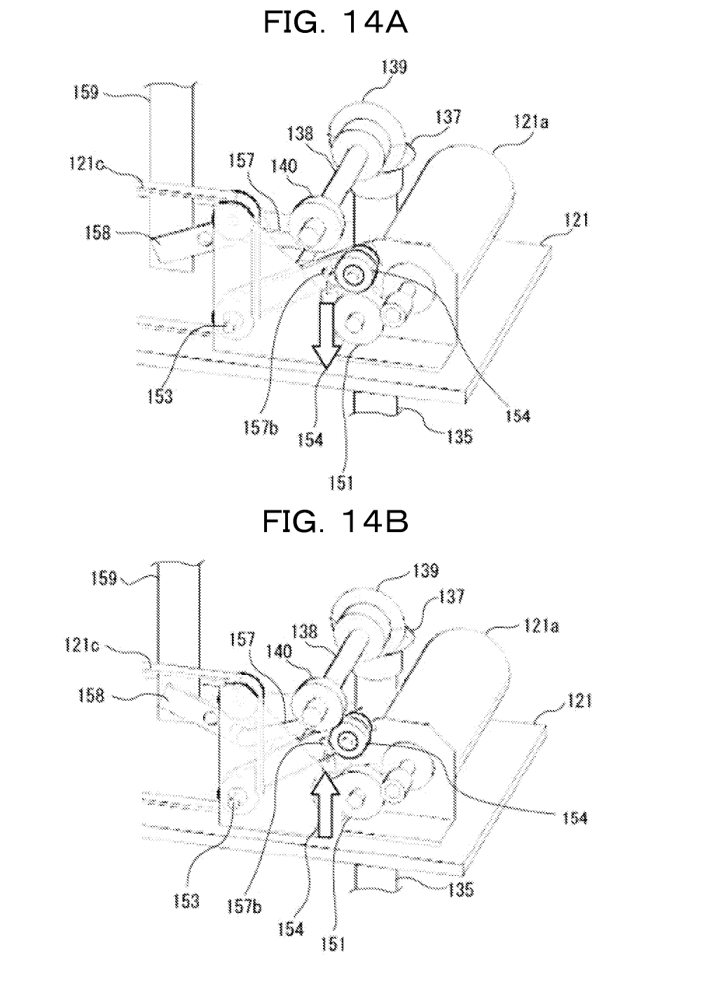

The article transport system 100 includes the alternative power supplier 130 configured to supply the second transport device 120 with power exerted by the power part provided to the first transport device 110. The power part provided to the first transport device 110 may be the Z movement motor 112c. The article transport system 100 includes the power switcher 150 configured to switch the power source for the second transport device 120 from the motor 121a provided to the second transport device 120 to the alternative power supplier 130. FIG. 5 illustrates an example of a perspective view of an alternative power supplier and a power switcher. As an example, FIG. 5 illustrates a perspective view of the alternative power supplier 130 and the power switcher 150 of the article transport system 100. FIG. 6 illustrates an example of a perspective view of a alternative power supplier. As an example, FIG. 6 illustrates a perspective of the alternative power supplier 130 of the article transport system 100. FIG. 7A illustrates an example of an enlarged view of a first transmission shaft and a second transmission shaft. As an example, FIG. 7A illustrates an enlarged view of an area including a first transmission shaft 135 and a second transmission shaft 138 included in the alternative power supplier 130. FIG. 7B illustrates an example of an enlarged view of a drive chain. As an example, FIG. 7B illustrates an area including a drive chain 134 included in the alternative power supplier 130. FIGS. 8A to 8C illustrate an example of an operation of an alternative power supplier. As an example, FIGS. 8A to 8C illustrate an example of an operation of the alternative power supplier 130. FIG. 9 illustrates an example of a power switcher. As an example, FIG. 9 illustrates a main portion of the power switcher 150. FIG. 10 illustrates an example of a swing member and a timing belt. As an example, FIG. 10 illustrates an example of a swing member 152 and a timing belt 170 included in the power switcher 150. FIG. 11 illustrates an example of a link mechanism. As an example, FIG. 11 illustrates a perspective of an area around a link mechanism included in the power switcher 150. FIG. 12A illustrates an example of a front view of the link mechanism. As an example, FIG. 12A illustrates a front view of the link mechanism included in the power switcher 150. FIG. 12B illustrates an example of a plan view of a link mechanism. As an example, FIG. 12B illustrates a plan view of the link mechanism included in the power switcher 150. FIG. 12C illustrates an example of a side view of a link mechanism. As an example, FIG. 12C illustrates a side view of the link mechanism included in the power switcher 150. FIGS. 13A to 13C illustrate an example of an operation of a power switcher. FIG. 14A illustrates an example of a state where a power source for a second transport device is a motor of a second transport device. As an example, FIG. 14A illustrates a state where the power source for the second transport device 120 is switched to the motor 121a of the second transport device 120 by the power switcher 150. FIG. 14B illustrates an example of a state in which a power source of a second transport device is an alternative power supplier. As an example, FIG. 14B illustrates a state where the power source for the second transport device 120 is switched to the alternative power supplier 130 by the power switcher 150.

The alternative power supplier 130 supplies the second transport device 120 with power output by the Z movement motor 112c provided to the first transport device 110. The alternative power supplier 130 supplies, as power for the second transport device 120, the power output by the Z movement motor 112c provided to the lower robot 112. The alternative power supplier 130 includes a first sprocket 131 and a second sprocket 132 placed on a bottom portion of the first casing 2. The second sprocket 132 is integrally provided with a first transmission gear 133. The drive chain 134 is looped around the first sprocket 131 and the second sprocket 132. The drive chain 134 is provided with protrusion portions 134a protruding sideways. The drive chain 134 rotates when the lower robot 112 becomes in contact with any of the protrusion portions 134a and moves in the Z direction.

The alternative power supplier 130 includes the first transmission shaft 135 provided with a second transmission gear 136 at a lower end portion of the first transmission shaft 135. The second transmission gear 136 meshes with the first transmission gear 133. Thus, when the drive chain 134 rotates, the first transmission shaft 135 rotates. The first transmission shaft 135 is provided with a third transmission gear 137 at an upper end portion of the first transmission shaft 135. The third transmission gear 137 may be a bevel gear. The third transmission gear 137 is exposed above the base portion 121 included in the second transport device 120.

The alternative power supplier 130 includes the second transmission shaft 138 provided on the base portion 121. The second transmission shaft 138 is provided with a fourth transmission gear 139 at one end of the second transmission shaft 138. The second transmission shaft 138 is provided with a fifth transmission gear 140 at the other end of the second transmission shaft 138. The fourth transmission gear 139 may be a bevel gear and meshes with the third transmission gear 137. The fifth transmission gear 140 meshes with a seventh transmission gear 154. The seventh transmission gear 154 is included in the power switcher 150. When the fifth transmission gear 140 meshes with the seventh transmission gear 154, the second transport device 120 is supplied with power output by the Z movement motor 112c provided to the lower robot 112, and thereby the cart 121d moves.

As illustrated in FIG. 8A, under normal circumstances, the lower robot 112 operates in a region where it does not come into contact with the protrusion portion 134a. Once an operation command is issued to the alternative power supplier 130, the lower robot 112 is moved by the X movement motor 112e to an operation start position, illustrated in FIG. 8B, where the lower robot 112 comes into contact with the protrusion portion 134a. Then, as illustrated in FIG. 8C, the lower robot 112 moves in the Z direction. The Z movement motor 112c causes the lower robot 112 to press the protrusion portion 134a until a desired feed amount is achieved. Thereby, power output by the Z movement motor 112c is supplied to the second transport device 120 via the alternative power supplier 130.

The power switcher 150 switches the power source for the second transport device 120 from the motor 121a provided to the second transport device 120 to the alternative power supplier 130. The power switcher 150 is actuated by operation of the upper robot 111. The power switcher 150 includes a sixth transmission gear 151. The sixth transmission gear 151 may be installed in a state where the sixth transmission gear 151 meshes with the pinion gear 121a1 of the motor 121a. The power switcher 150 includes the swing member 152 which swings with a shaft portion 153 as a point of support. The swing member 152 has a pin hole 152a, and a first pin portion 157b is inserted into the pin hole 152a. As illustrated in FIG. 10, the seventh transmission gear 154 and a first transmission pulley 155 are provided at one end of the swing member 152. The seventh transmission gear 154 meshes with the fifth transmission gear 140 or the sixth transmission gear 151 selectively depending on the status of the swing member 152. A second transmission pulley 156 and the drive pulley 121c1 are provided at the other end of the swing member 152. The timing belt 170 is looped around the first transmission pulley 155 and the second transmission pulley 156. When the seventh transmission gear 154 rotates, the rotation is transmitted to the drive pulley 121c1, and thereby the drive belt 121c rotates. When the seventh transmission gear 154 meshes with the sixth transmission gear 151, the second transport device 120 is operated by the motor 121a. When the seventh transmission gear 154 meshes with the fifth transmission gear 140, the second transport device 120 is operated by the alternative power supplier 130. The swing member 152 is biased toward the base portion 121 by a spring member 180, and under normal circumstances, the seventh transmission gear 154 may mesh with the sixth transmission gear 151.

The gear with which the seventh transmission gear 154 meshes may be changed by the swing of the swing member 152. The power switcher 150 includes a link mechanism illustrated in FIGS. 11 and 12A to 12C. The link mechanism includes a crank-shaped first link member 157. The first link member 157 includes a shaft portion 157a, the first pin portion 157b, and a second pin portion 157c. The first pin portion 157b is inserted into the pin hole 152a provided in the swing member 152 as a revolute pair. The link mechanism includes a second link member 158. The second link member 158 pivotally and rotatably supported by a shaft portion 158a provided in the base portion 121. The second link member 158 is provided with an oval slide groove 158b at one end of the second link member. The slide groove 158b slidably engages with the second pin portion 157c of the first link member 157. The second link member 158 is provided with a pin portion 158c at the other end of the second link member.

The link mechanism includes a third link member 159 extending vertically. The third link member 159 includes an attachment hole 159a at a lower end portion of the third link member. The third link member 159 includes an attachment pin portion 159b at an upper end portion of the third link member. The pin portion 158c of the second link member 158 is inserted to the attachment hole 159a as a revolute pair. The attachment pin portion 159b has a shape protruding in both directions along the X direction. The link mechanism includes a fourth link member 160. The fourth link member 160 includes a push-in pin portion 160a at one end of the fourth link member. The fourth link member 160 has a pin hole 160b at the other end of the fourth link member. One end of the attachment pin portion 159b provided to the third link member 159 is inserted into the pin hole 160b as a revolute pair. The push-in pin portion 160a slidably engages with a guide groove 161a provided in a guide plate 161 fixed to the first casing 2. The push-in pin portion 160a is pushed by the upper robot 111. The link mechanism includes a fifth link member 162. The fifth link member 162 includes a shaft hole 162a at one end of the fifth link member. The fifth link member 162 includes a slide groove 162b at the other end of the fifth link member. A pin member provided in the first casing 2 is inserted into the shaft hole 162a as a revolute pair. The other end of the attachment pin portion 159b of the third link member 159 slidably engages with the slide groove 162b.

In such a link mechanism, when the push-in pin portion 160a is pushed in the Z direction by the upper robot 111, the fourth link member 160 pushes the third link member 159 up. With this, the second link member 158 rotates with the shaft portion 158a as a point of support. Consequently, the side of the second link member 158 where the slide groove 158b is provided lowers, and thereby the first link member 157 rotates with the shaft portion 157a as a point of support. As a result, the first pin portion 157b side of the first link member 157 rises. When the first pin portion 157b side rises, the swing member 152 swings, lifting the seventh transmission gear 154. As a result of this, the seventh transmission gear 154 is switched from being meshing with the sixth transmission gear 151 to meshing with the fifth transmission gear 140. The power source for the second transport device 120 may be switched in this manner. When the power source for the second transport device 120 is switched, the second transport device 120 is disconnected from the motor 121a having a problem. Thus, load on the second transport device 120 may be reduced after the switch.

As illustrated in FIG. 13A, under normal circumstances, the upper robot 111 operates in a region where the upper robot 111 does not come into contact with the push-in pin portion 160a. Once an operation command is issued to the power switcher 150, the upper robot 111 is moved by the X movement motor 111e to an operation start position where the upper robot 111 comes into contact with the push-in pin portion 160a, as illustrated in FIG. 13B. Then, as illustrated in FIG. 13C, the Z movement motor 111c causes the upper robot 111 to push the push-in pin portion 160a. Thereby, the power source for the second transport device 120 is set to the alternative power supplier 130. As long as the upper robot 111 keeps pushing the push-in pin portion 160a, the power switcher 150 maintains the state where the alternative power supplier 130 supplies the power source for the second transport device 120. Thus, the library controller 20 performs control in such a manner that, while the upper robot 111 actuates the power switcher 150, power output by the lower robot 112 is supplied to the second transport device 120 via the alternative power supplier 130.

The alternative power supplier 130 and the power switcher 150 may operate with the upper robot 111 and the lower robot 112 being interchanged. For example, power of the upper robot 111 may be supplied by the alternative power supplier 130 as power for the second transport device 120, and operation of the lower robot 112 may actuate the power switcher 150.

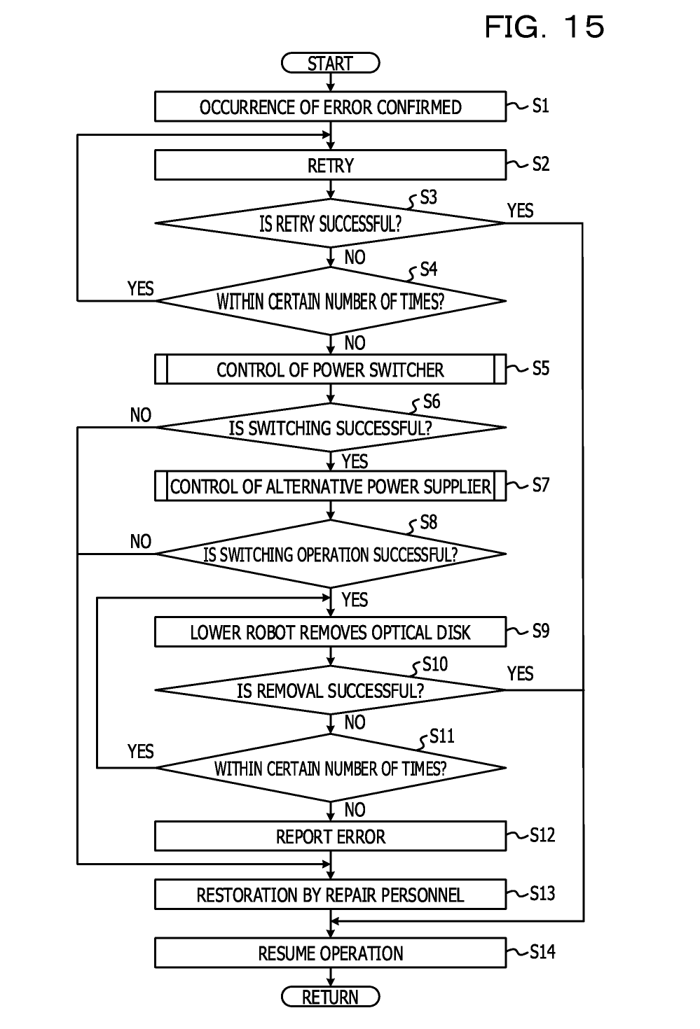

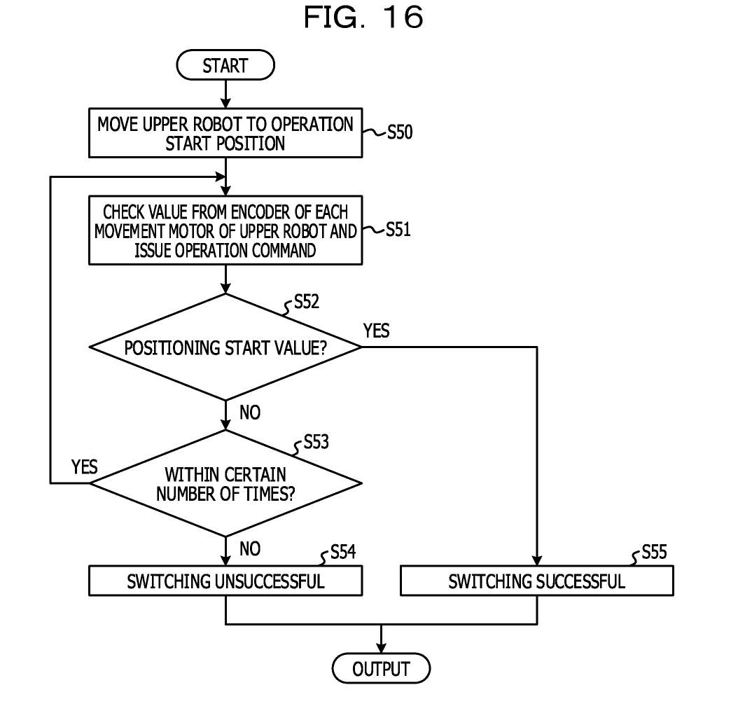

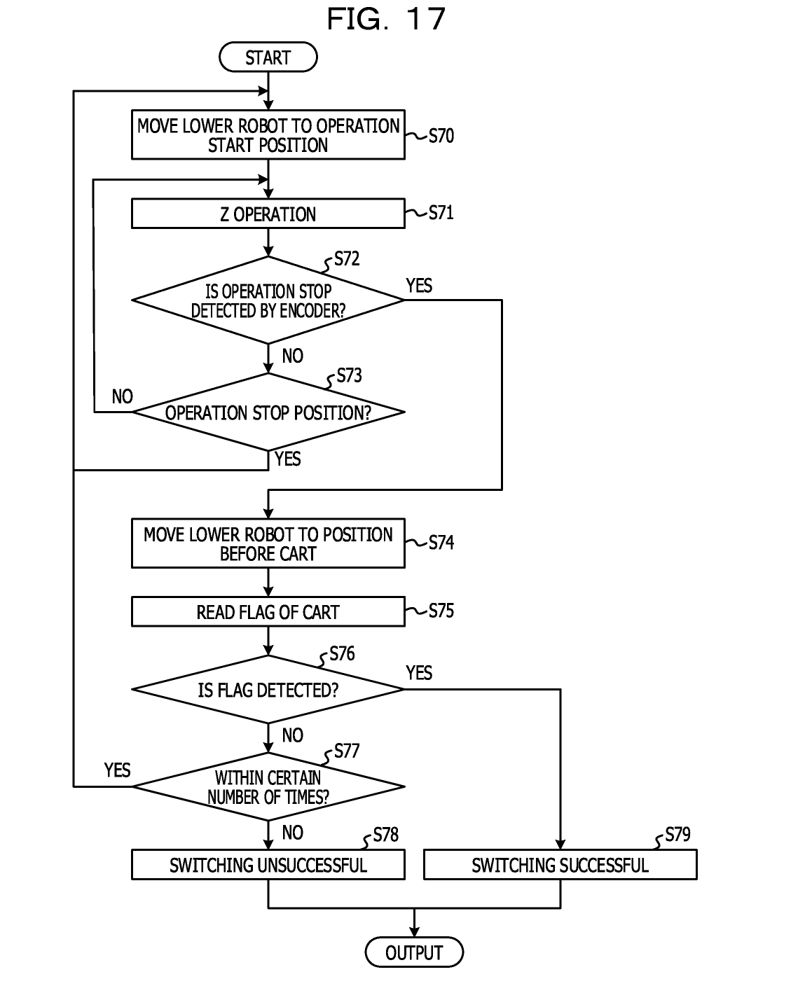

FIG. 15 illustrates an example of control of an article transport system. FIG. 16 illustrates an example of control of an power switcher. FIG. 17 illustrates an example of control of an alternative power supplier. Control illustrated in FIGS. 15 to 17 may be performed by, for example, the upper robot controller 20a, the lower robot controller 20b, and the library controller 20 coupled to these robot controllers, of the article transport system 100.

Control of the article transport system 100 may be performed continuously during operation of the library apparatus 1. When occurrence of an error is confirmed in Operation S1, the same command is retried in Operation S2. The occurrence of an error may be determined based on a comparison between a command value and a value acquired from each encoder. For example, the occurrence of an error may be determined if the value acquired from the encoder is not what the command value indicates. For example, an error may occur when the second transport device 120 stops at a position where the second transport device 120 is unable to receive or deliver an article from or to the first transport device 110. For example, a cause of the error may include a failure in the motor 121a being the power part of the second transport device 120.

In Operation S3, it is determined whether the retry performed in Operation S2 is successful or not. This determination may be performed based on a value acquired from the encoders. If a result of the determination in Operation S3 is Yes, processing proceeds to Operation S14 to resume the operation, and the processing is returned. If a result of the determination in Operation S3 is No, the processing proceeds to Operation S4. In Operation S4, it is determined whether the retry is within a certain number of retries or not. If a result of the determination in Operation S4 is Yes because the retry has not reached the certain number of retries, the processing in Operation S2 and Operation S3 may be repeated. If a result of the determination in Operation S4 is No, the processing proceeds to Operation S5. In Operation S5, control of the power switcher illustrated in FIG. 16 is performed.

In Operation S50, the upper robot 111 moves to the operation start position. In Operation S51, the upper robot 111 is operated while values from the encoders for the movement motors of the upper robot 111 are monitored. In Operation S52, it is determined whether or not the upper robot 111 is located at a position for power switching, based on whether or not a value from the encoders indicates a positioning target value. When the upper robot 111 operates, the swing member 152 swings to cause the seventh transmission gear 154 to release the meshing with the sixth gear 151 and instead mesh with the fifth transmission gear 140. If a result of the determination in Operation S52 is Yes, the processing proceeds to Operation S55, and a switch-success flag is set. If a result of the determination in Operation S52 is No, the processing proceeds to Operation S53 to determine whether the execution of the switching operation is within a certain number of executions or not. If a result of the determination in Operation S53 is Yes because the execution of switching operation has not reaches the certain number of executions, the processing of Operation S51 and Operation S52 is repeated. If a result of the determination in Operation S53 is No, the processing proceeds to Operation S54. In Operation S54, a switch-fail flag is set.

After the switch-success or switch-fail flag is set in Operation S5, the processing proceeds to Operation S6. In Operation S6, it is determined based on the flag set in Operation S5 whether the power switching is successful or not. If a result of the determination in Operation S6 is No, the processing proceeds to Operation S13. In Operation S13, a repair personnel performs restoration. After the restoration is performed by the repair personnel, the processing proceeds to Operation S14, and the operation is resumed. If a result of the determination in Operation S6 is Yes, the processing proceeds to Operation S7. In Operation S7, control of the alternative power supplier illustrated in FIG. 17 is performed.

In Operation S70, the lower robot 112 moves to the operation start position. For example, the lower robot 112 comes into contact with the protrusion portion 134a of the drive chain 134. In Operation S71, the lower robot 112 moves in the Z direction. For example, the amount of the movement in the Z direction may be determined based on the distance from a stop position of the cart 121d of the second transport device 120 to a position where the cart 121d is able to receive and deliver an optical disk from and to the lower robot 112. The position where reception and delivery of an optical disk are enabled may be a position where the cart 121d comes into a stopper by moving closest to the motor 121a. In Operation S72, the Z movement encoder 112d checks whether the Z movement motor 112c is stopped or not. It may be determined that the cart 121d has moved to the position where the cart 121d is in contact with the stopper, based on the above check that the Z movement motor 112c is stopped. If a result of the determination in Operation S72 is No, the processing proceeds to Operation S73. In Operation S73, it may be determined whether the lower robot 112 has moved a distance indicated by a maximum value which allows the lower robot 112 to move to the back in the Z direction. If a result of the determination in Operation S73 is No, the processing returns to Operation S71, and the lower robot 112 keeps moving to the back. If a result of the determination in Operation S73 is Yes, the processing from Operation S70 is repeated. When the lower robot 112 has moved a distance indicated by the maximum value to the back in the Z direction, the lower robot 112 returns to the operation start position and moves in the Z direction again to allow the cart 121d to move more. The lower robot 112 performs retreat operation in the X direction once before returning to the operation start position. Thus, contact with the protrusion portion 134a may be avoided.

When a result of the determination in Operation S72 is Yes, the processing proceeds to Operation S74. In Operation S74, the lower robot 112 is moved to a position before the cart 121d. In moving the cart 121d, the lower robot 112 operates at a position near the bottom portion of the first casing 2. Thus, in Operation S74, the lower robot 112 is moved up to a position where the lower robot 112 is able to receive or deliver an optical disk from or to the cart 121d. In Operation S75, a flag provided to the cart 121d is read by an imaging device of the lower robot 112. Positioning is performed by a hand provided to the lower robot 112 so that an optical disk may be certainly received or delivered. In Operation S76, it is determined whether the flag is detected or not. If a result of the determination in Operation S76 is Yes, the processing proceeds to Operation S79, and a flag indicating that switching operation is successful is set. If a result of the determination in Operation S76 is No, the processing proceeds to Operation S77. In Operation S77, it is determined whether the execution of the switching operation is within a certain number of executions or not. If a result of the determination in Operation S77 is Yes because the execution of the switching operation has not reached the certain number of executions, the processing from Operation S70 is repeated. If a result of the determination in Operation S77 is No, the processing proceeds to Operation S78, and a flag indicating the switching operation is unsuccessful is set.

After the flag indicating switching success or fail is set in Operation S7, the processing proceeds to Operation S8. In Operation S8, it is determined whether the switching operation is successful or not. If a result of the determination in Operation S8 is No, the processing proceeds to Operation S13. If a result of the determination in Operation S8 is Yes, the processing proceeds to Operation S9 to cause the lower robot 112 to perform removal of the optical disk, and proceeds to Operation S10. In Operation S10, it is determined whether the optical disk is successfully removed or not. The determination on whether the optical disk is successfully removed or not may be made based on a value acquired from the hand encoder 112j. If a result of the determination in Operation S10 is Yes, the processing proceeds to Operation S14 to resume operation. If a result of the determination in Operation S14 is No, the processing proceeds to Operation S11. In Operation S11, it is determined whether execution of the operation for optical-disk removal is within a certain number of executions or not. If a result of the determination in Operation S11 is Yes because the execution of the removal operation has not reached the certain number of executions, the processing from Operation S9 is repeated. If a result of the determination in Operation S11 is No, the processing proceeds to Operation S12 to report an error. In Operation S13, a repair personnel performs restoration. After the restoration is performed by the repair personnel, the processing proceeds to Operation S14, and the operation is resumed. After Operation S14, the processing is returned.

In the article transport system 100, even when there is a problem in the second transport device 120 configured to transport a transportable recording medium between the first casing 2 and the second casing 3, continuance of the operation of the article transport system 100 may be achieved with a simple mechanism. The article transport system 100 may continue its operation by using the first transport device 110 of the first casing 2 or the second casing 3. For this reason, continuance of operation may be achieved with a simple mechanism without using an additional drive part. When the operation source for the second transport device 120 is switched, the motor 121a is disconnected to possibly reduce the load on operating the second transport device 120.

The article transport system may be applied to the library apparatus 1. For example, the article transport system may be used for transport of an article in a warehouse. For example, the article transport system may be used in a case multiple warehouses are coupled and operated, and each warehouse has multiple article storage areas set therein.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. An article transport system comprising:
a first transport device configured to transport an article within a first article storage area or a second article storage area;
a second transport device configured to transport the article between the first article storage area and the second article storage area;
an alternative power supplier configured to supply the second transport device with first power output by a first power part in the first transport device; and
a power switcher configured to switch a power source for the second transport device from a second power part in the second transport device to the alternative power supplier, based on operation of the first transport device.

2. The article transport system according to claim 1, wherein
the first transport device includes a first operation part placed at an upper side of the first transport device and a second operation part placed at a lower side of the first transport device.

3. The article transport system according to claim 2, wherein
the power switcher is actuated by second power exerted by one operation part of the first operation part and the second operation part, and
third power exerted by the other operation part of the first operation part and the second operation part is supplied to the second transport device via the alternative power supplier as the first power.

4. The article transport system according to claim 3, further comprising:
a controller configured to supply the third power to the second transport device via the alternative power supplier while causing the one operation part to actuate the power switcher.

5. The article transport system according to claim 2, wherein
the alternative power supplier includes a drive chain configured to be rotated by the other operation part.

6. The article transport system according to claim 2, wherein
the drive chain includes a protrusion portion, and
the other operation part supplies the first power to the second transport device by pushing the protrusion portion when operating at a position where the other operation part comes into contact with the protrusion portion.

7. The article transport system according to claim 5, wherein
the alternative power supplier includes a shaft coupled to the second transport device and configured to rotate with rotation of the drive chain.

8. The article transport system according to claim 1, wherein
the power switcher includes a first gear and a second gear, and
the first gear selectively meshes with the second gear or a third gear in the second transport device.

9. The article transport system according to claim 8, wherein
the first gear is switched from meshing with the second gear to meshing with the third gear based on an operation of the first transport device.

10. A library apparatus comprising:
an article transport system configured to transport a recording medium; and
a library controller configured to control the article transport system, wherein
the article transport system includes:
a first transport device configured to transport an article within a first article storage area or a second article storage area,
a second transport device configured to transport the article between the first article storage area and the second article storage area,
an alternative power supplier configured to supply the second transport device with first power output by a first power part in the first transport device, and
a power switcher configured to switch a power source for the second transport device from a second power part in the second transport device to the alternative power supplier, based on operation of the first transport device.

11. The library apparatus according to claim 10, wherein
the first transport device includes a first operation part placed at an upper side of the first transport device and a second operation part placed at a lower side of the first transport device.

12. The library apparatus according to claim 11, wherein
the power switcher is actuated by second power exerted by one operation part of the first operation part and the second operation part, and
third power exerted by the other operation part of the first operation part and the second operation part is supplied to the second transport device via the alternative power supplier as the first power.

13. The library apparatus according to claim 11, wherein
the alternative power supplier includes a drive chain configured to be rotated by the other operation part.

14. The library apparatus according to claim 11, wherein
the drive chain includes a protrusion portion, and
the other operation part supplies the first power to the second transport device by pushing the protrusion portion when operating at a position where the other operation part comes into contact with the protrusion portion.

15. The library apparatus according to claim 13, wherein
the alternative power supplier includes a shaft coupled to the second transport device and configured to rotate with rotation of the drive chain.

16. The library apparatus according to claim 10, wherein
the power switcher includes a first gear and a second gear, and
the first gear selectively meshes with the second gear or a third gear in the second transport device.

17. The library apparatus according to claim 16, wherein
the first gear is switched from meshing with the second gear to meshing with the third gear based on an operation of the first transport device.

18. An article transport method comprising:
transporting, by a first transport device, an article within a first article storage area or a second article storage area;
transporting, by a second transport device, the article between the first article storage area and the second article storage area; and
switching a power source for the second transport device from a second power part in the second transport device to a first power part in the first transport device, based on operation of the first transport device.

19. The article transport method according to claim 18, further comprising:
actuating by second power exerted by one operation part of a first operation part and a second operation part which are included in the first transport device; and
supplying power exerted by the other operation part of the first operation part and the second operation part to the second transport device via the alternative power supplier.
